(19) United States
(12) Patent Application Publication
(10) Pub. No.: US 2015/0268509 A1
(43) Pub. Date: Sep. 24, 2015

(54) POLARIZING PLATE AND LIQUID CRYSTAL DISPLAY HAVING THE SAME

(71) Applicant: Samsung Display Co., Ltd., Yongin-City (KR)

(72) Inventors: Kyeongha KIM, Hwaseong-si (KR); Min Oh CHOI, Cheonan-si (KR); Boo-Kan KI, Yongin-si (KR); Hee Wook DO, Cheonan-si (KR); SEUNGBEOM PARK, Hwaseong-si (KR); YongHwan SHIN, Yongin-si (KR)

(21) Appl. No.: 14/602,655

(22) Filed: Jan. 22, 2015

(30) Foreign Application Priority Data
Mar. 20, 2014 (KR) 10-2014-0032904

(51) Int. Cl. G02F 1/1335; G02F 1/1347; G02F 1/13363

(52) U.S. Cl. CPC G02F 1/133502; G02F 1/133528; G02F 1/13363; G02F 1/13471

(57) ABSTRACT

A liquid crystal display includes: a liquid crystal panel which displays an image on a surface thereof; two polarizing films disposed on opposing surfaces of the liquid crystal panel, respectively; two compensation films disposed between the liquid crystal panel and the two polarizing films, respectively; two protective films disposed on outer surfaces of the two polarizing films, respectively, and an anti-glare layer disposed on the two protective film in a direction of displaying the image.

This application claims priority to Korean Patent Application No. 10-2014-0032904, filed on Mar. 20, 2014, and all the benefits accruing therefrom under 35 U.S.C. §119, the content of which in its entirety is herein incorporated by reference.

### BACKGROUND

1. Field

The disclosure herein relates to a polarizing plate and a liquid crystal display (“LCD”) including the polarizing plate.

2. Description of the Related Art

An LCD typically includes a liquid crystal panel and a pair of polarizing plates provided on top and bottom of the liquid crystal panel. Generally, liquid crystal panels include an array substrate including a plurality of pixels arranged in a matrix form, an opposite substrate facing the array substrate, and a liquid crystal layer disposed between the array substrate and the opposite substrate and including a plurality of liquid crystals. The liquid crystal panel is determined diversely in a liquid crystal mode according to an array structure and a liquid crystal phase of liquid crystals included in the liquid crystal layer. Typically, there are liquid crystal panels using a nematic liquid crystal phase and liquid crystal panels using a smectic liquid crystal phase.

Twisted nematic LCDs, representative LCDs using the nematic liquid crystal phase, have better light transmittance but have a narrower viewing angle relatively to other LCDs.

Twisted nematic LCDs use a discotic liquid crystal (“DLC”) compensation film to compensate the viewing angle. The DLC compensation film is manufactured by coating a tri-acetyl-cellulose film with DLCs. It is complicated and costly to manufacture the DLC compensation film.

### SUMMARY

The disclosure provides a liquid crystal display (“LCD”) including a compensation film and a polarizing film.

Exemplary embodiments of the invention provide LCDs including a liquid crystal panel which displays an image on a surface thereof, two polarizing films disposed on opposing surfaces of the liquid crystal panel, respectively, two compensation films disposed between the liquid crystal panel and the two polarizing films, respectively, two protective films disposed on outer surfaces of the two polarizing films, and an anti-glare layer disposed on one of the two protective films in a direction of displaying the image.

In an exemplary embodiment, the anti-glare layer may include a matrix having an uneven portion on a surface thereof.

In an exemplary embodiment, the anti-glare layer may further include particles disposed in the matrix.

In an exemplary embodiment, the matrix and the particles may have different refractive indexes from each other.

In an exemplary embodiment, the two polarizing films may include a first polarizing film disposed on one surface of the liquid crystal panel and having a first polarizing axis and a second polarizing film disposed on another surface of the liquid crystal panel and having a second polarizing axis. In such an embodiment, the two compensation films may include a first compensation film disposed between the liquid crystal panel and the first polarizing film and having a first optical axis and a second compensation film disposed between the liquid crystal panel and the second polarizing film and having a second optical axis.

In an exemplary embodiment, one surface of each of the first and second compensation films may define an x-y plane on the respective compensation film, the first or second optical axis of each of the first and second compensation films defines a z′-axis on the respective compensation films, a surface perpendicular to the first or second optical axis and passing an x-axis of the x-y plane on each of the first and second compensation films may define an x-y′ plane on the respective compensation film, a first retardation value (Ro′) of each of the first and second compensation films is defined as (nx−ny′)×d, a second retardation value (Rth′) of each of the first and second compensation films is defined as [(nx+ny′)/2−nz′]×d, the first retardation value and the second retardation value may satisfy the following inequation: 0.92≦Rₜₕ′/Rₒ′≦4.75, where nx denotes a refractive index of the respective compensation film in the x-axis, ny′ denotes a refractive index of the respective compensation film in the y′-axis, nz′ denotes a refractive index of the respective compensation film in the z′-axis, and d denotes a thickness of the respective compensation film in a z-axis perpendicular to the x-y plane.

In an exemplary embodiment, the first retardation value of each of the first and second compensation films may be a retardation value with respect to the x-y′ plane thereon, and the second retardation value of each of the first and second compensation films may be a retardation value with respect to the z′-axis thereon.

In an exemplary embodiment, a total haze value of the anti-glare layer may be about 45 or greater when the second retardation value is from about 145 nanometers (nm) to about 155 nm, the total haze value of the anti-glare layer may be about 37 or greater when the second retardation value is in a range from about 155 nm to about 165 nm, the total haze value of the anti-glare layer may be about 30 or greater when the second retardation value is in a range from about 165 nm to about 175 nm, and the total haze value of the anti-glare layer may be greater than zero (0) when the second retardation value is in a range from about 175 nm to about 185 nm.

In an exemplary embodiment, each of the first and second compensation films, an angle between the optical axis and the z-axis of each of the first and second compensation films may be in a range from about 10 degrees to about 25 degrees.

In an exemplary embodiment, the LCD may further include a first substrate, a second substrate opposite to the first substrate, and liquid crystals disposed between the first substrate and the second substrate, where the liquid crystals are twisted nematic liquid crystals.

In an exemplary embodiment, dielectric constant anisotropy of the twisted nematic liquid crystals may be in a range from about 7 to about 13.

In an exemplary embodiment, a retardation value of the twisted nematic liquid crystals is in a range from about 400 nm to about 480 nm.

In an exemplary embodiment, the LCD may further include a first alignment film disposed between the first substrate and the liquid crystals and aligned in a direction of the first polarizing axis, and a second alignment film disposed between the second substrate and the liquid crystals and aligned in a direction of the second polarizing axis.

In an exemplary embodiment, each of the two compensation films comprises thermoplastic resin.

In an exemplary embodiment, refractive indices each of the compensation films satisfy the following inequation: nx>ny′≧nz′.

### BRIEF DESCRIPTION OF THE DRAWINGS

The above and other features of the invention will become more apparent by describing in further detail exemplary embodiments thereof with reference to the accompanying drawings, in which:

FIG. 1 is a cross-sectional view of an exemplary embodiment of a liquid crystal display (“LCD”) according to the invention;

FIG. 2 is a top view of the LCD of FIG. 1;

FIG. 3 is a cross-sectional view taken along line I-I′ of the LCD shown in FIG. 2;

FIG. 4 is an exploded perspective view of the LCD of FIG. 1;

FIG. 5 is a perspective view of an exemplary embodiment of a first compensation film of FIG. 4;

FIG. 6 is a cross-sectional view of an exemplary embodiment of an anti-glare film on a first protective film, according to the invention;

FIGS. 7A to 7C are cross-sectional views illustrating light passing through only the first protective film or both the first protective film and the anti-glare film; and

FIGS. 8A to 8D are graphs illustrating variations in values of x and y in color coordinates versus grayscale level in comparative examples and exemplary embodiments of the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the invention will be described in detail with reference to the attached drawings.

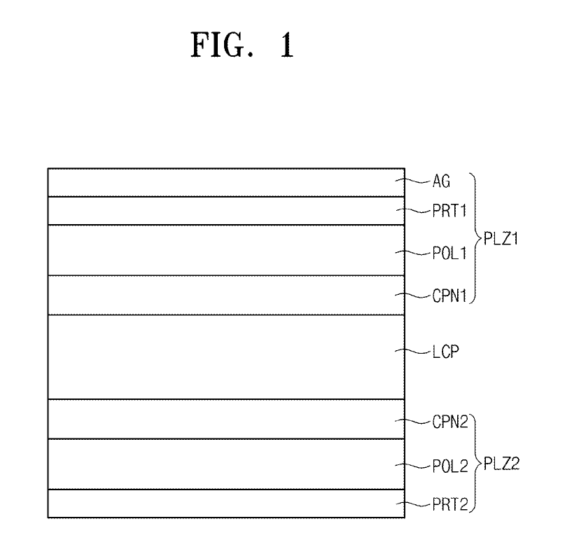

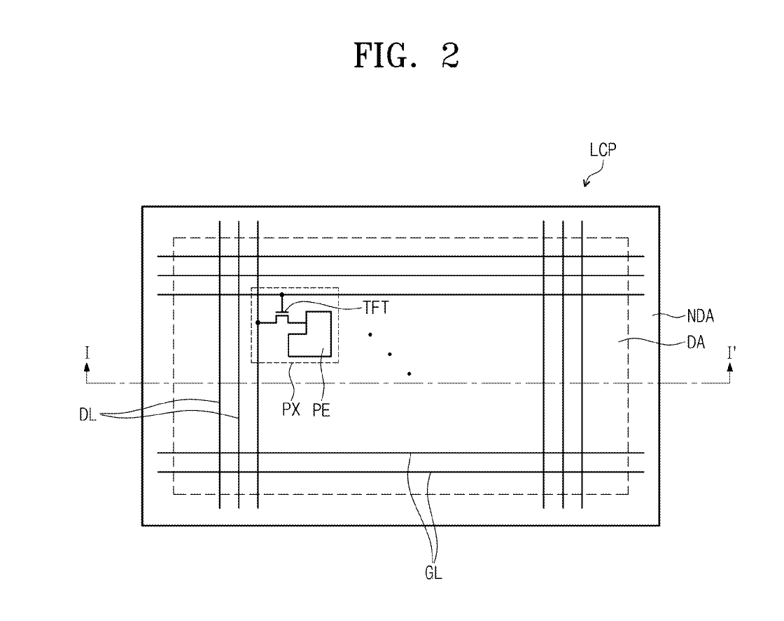

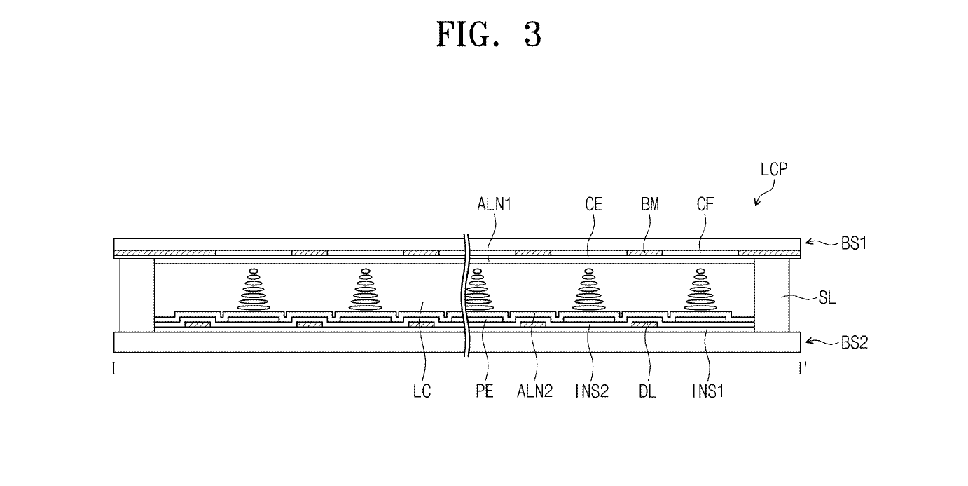

FIG. 1 is a cross-sectional view of an exemplary embodiment of a liquid crystal display (“LCD”) according to the invention. FIG. 2 is a top view of the LCD of FIG. 1. FIG. 3 is a cross-sectional view taken along line I-I′ of the LCD shown in FIG. 2.

Referring to FIGS. 1 to 3, an exemplary embodiment of the LCD includes a liquid crystal panel LCP and polarizing plates disposed on opposing surfaces of the liquid crystal panel LCP.

The liquid crystal panel LCP includes a first substrate BS1, a second substrate BS2 disposed opposite to the first substrate BS1, a sealing element SL that seals the first substrate BS1 and the second substrate BS2, and liquid crystals LC disposed between the first substrate BS1 and the second substrate BS2.

The second substrate BS2 includes a display area, in which a plurality of pixels PX are disposed to display images, and a non-display area NDA corresponding to at least one side of the display area DA.

In such an embodiment, as shown in FIG. 3, a wiring portion for transmitting a signal and the pixels PX is disposed on the second substrate BS2. The wiring portion includes a plurality of gate lines GL on the second substrate BS2 and a plurality of data lines DL crossing the gate lines GL. The pixels PX include thin film transistors TFT connected to the gate lines GL and the data lines DL and a pixel electrode PE connected to the thin film transistors TFT. Each of the thin film transistors TFT is connected to a corresponding one of the gate lines GL and a corresponding one of the data lines DL and applies a pixel voltage to the pixel electrode PE.

Each of the thin film transistors TFT includes a gate electrode, an active layer, a source electrode and a drain electrode. The gate electrode may be defined by a protruding portion of a corresponding one of the gate lines GL. A first insulating film INS1 that covers the gate electrode is disposed on the second substrate BS2. The active layer is disposed on the first insulating film INS1, and the source electrode and the drain electrode are disposed on the active layer and the source electrode and the drain electrode are spaced from each other to expose the active layer. In such an embodiment, the data lines DL is disposed on the first insulating film INS1. The source electrode may be defined by a protruding portion of a corresponding one of the data lines DL.

A second insulating film INS2 that covers the source electrode, the drain electrode, and the exposed active layer is disposed on the first insulating film INS1. The pixel electrode PE is disposed on the second insulating film INS2, and the pixel electrode PE is electrically connected to the drain electrode through a contact hole defined through the second insulating film INS for each pixel PX.

In such an embodiment, a common electrode CE is disposed on a surface of the first substrate BS1 facing the second substrate BS2. In such an embodiment, a color filter CF together with a black matrix BM is disposed on the first substrate BS1. The black matrix BM includes a plurality of opening areas facing the pixel electrode PE on the first substrate BS1 and having substantially the same shape as the pixel electrode PE. The color filter CF may be disposed in each of the opening areas of the black matrix BM. The color filter CF may display one of primary colors such as red, green and blue, for example.

The liquid crystals LC are disposed between the first substrate BS1 and the second substrate BS2. The liquid crystals LC may include twisted nematic liquid crystals. The twisted nematic liquid crystals may have dielectric constant anisotropy (Δε) in a range from about 7 to about 13. Also, a retardation value (Δnd) of the twisted nematic liquid crystals may be in a range from about 400 nanometers (nm) to about 480 nm. The dielectric constant anisotropy and the retardation value of the twisted nematic liquid crystals may vary based on properties of a polarizing film and a compensation film, which will be described later in detail.

The sealing element SL is disposed in the non-display area NDA between the first substrate BS1 and the second substrate BS2. The sealing element SL is disposed along a circumference of one of the first substrate BS1 and the second substrate BS2 and seals the liquid crystals LC.

A first alignment film ALN1 is disposed between the liquid crystals LC and the first substrate BS1, and a second alignment film ALN2 is disposed between the liquid crystals LC and the second substrate BS2. The first alignment film ALN1 and the second alignment film ALN2 face the liquid crystals LC, respectively.

In an exemplary embodiment, the polarizing plate may be disposed on both opposing surfaces of the liquid crystal panel LCP. In an alternative exemplary embodiment, the polarizing plate may be disposed only on one surface of the liquid crystal panel LCP. In an exemplary embodiment, where the polarizing plate is provided on both opposing surfaces of the liquid crystal panel LCP, the polarizing plate may include a first polarizing plate PLZ1 disposed on one surface, for example, a top surface, of the liquid crystal panel LCP and a second polarizing plate PLZ2 disposed on the other surface, for example, a bottom surface, of the liquid crystal panel LCP. In an alternative exemplary embodiment, where the polarizing plate is provided only on one surface of the liquid crystal panel LCP, another component having substantially same function as the polarizing plate in response to the polarizing plate may be disposed on the other surface of the liquid crystal panel LCP. Hereinafter, for convenience of description, an exemplary embodiment where the polarizing plate includes the first polarizing plate PLZ1 and the second polarizing plate PLZ2 will be described in detail. The first polarizing plate PLZ1 and the second polarizing plate PLZ2 will be described later in greater detail.

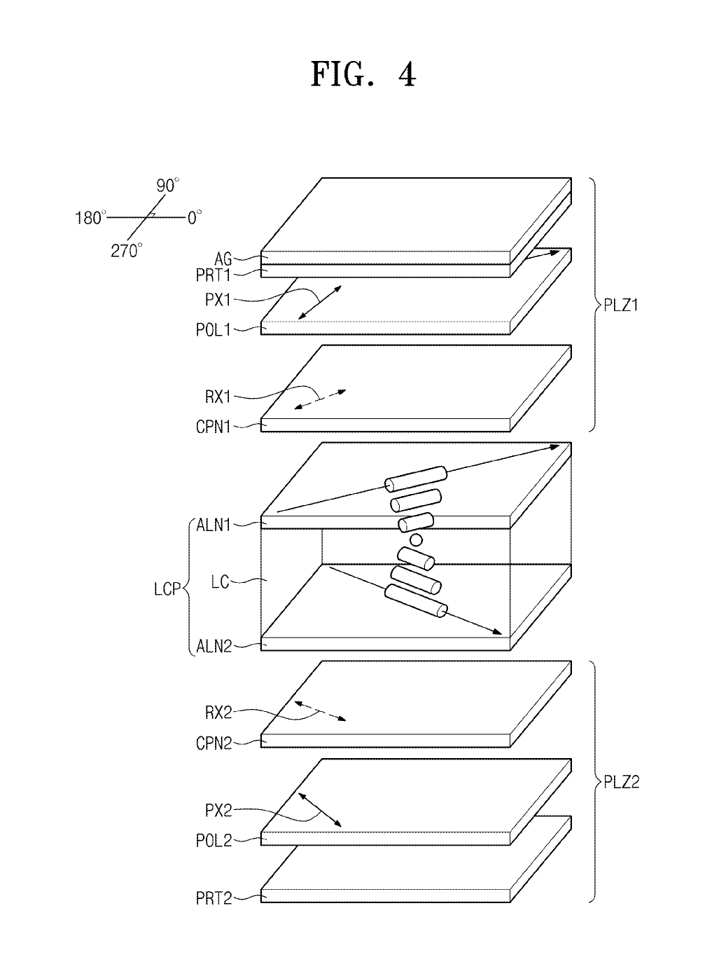

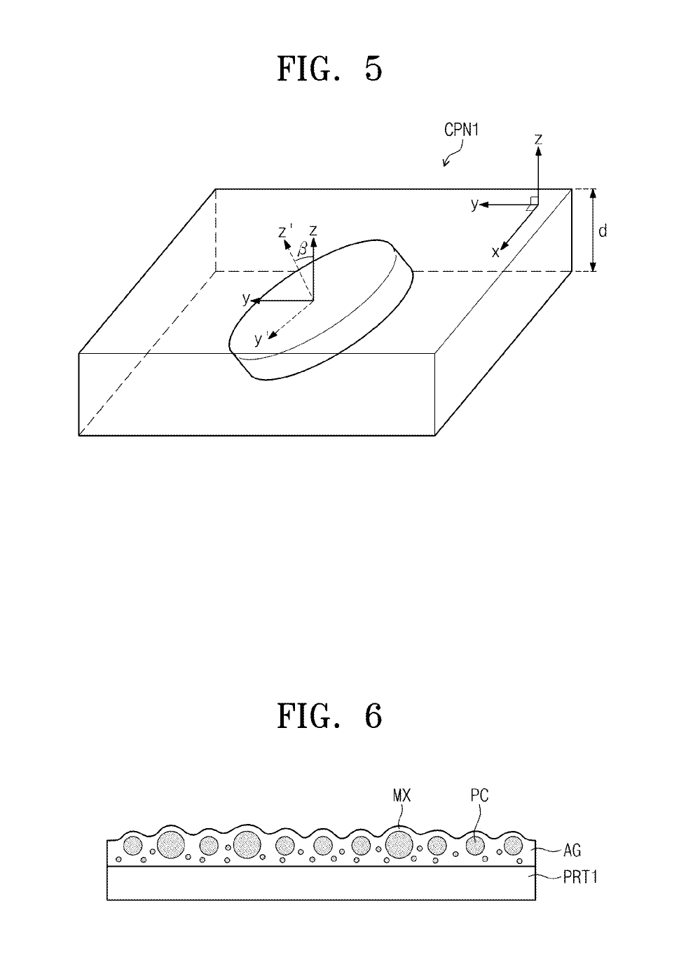

FIG. 4 is an exploded perspective view of the LCD of FIG. 1. FIG. 5 is a perspective view of an exemplary embodiment of a first compensation film CPN1 of FIG. 4. FIG. 4 illustrates relationships among components of the LCD. For convenience of illustration and description, some components, for example, a first substrate and a second substrate of a liquid crystal panel are omitted in FIG. 4.

Referring to FIGS. 4 and 5, the first polarizing plate PLZ1 and the second polarizing plate PLZ2 are disposed opposite to each other, while interposing the liquid crystal panel LCP therebetween.

The first polarizing plate PLZ1 includes the first compensation film CPN1 disposed on a top surface of the liquid crystal panel LCP, a first polarizing film POL1 disposed on the first compensation film CPN1, a first protective film PRT1 provided on the first polarizing film POL1, and an anti-glare film AG disposed on the first protective film PRT1.

The liquid crystal panel LCP has a rectangular shape having a pair of long sides and a pair of short sides. Hereinafter, as shown in FIG. 4, an angle is indicated based on one of directions, in which the long sides of the liquid crystal panel LCP extend. Herein, as shown in FIG. 4, one of directions, in which the short sides extend, is 90 degrees and another direction opposite thereto is 270 degrees, for example.

The first polarizing film POL1 absorbs light oscillating in a direction, thereby polarizing light penetrating the first polarizing film POL1 in a predetermined direction. In an exemplary embodiment, where the first polarizing film POL1 absorbs light oscillating in a first direction, e.g., a first polarizing axis PX1, the first polarizing axis PX1 may have a direction in a range of about 45±10 degrees.

The first polarizing film POL1 may include or formed of polymer resin elongated in a particular direction. The polymer resin may be polyvinyl alcohol resin. The polyvinyl alcohol resin may be obtained based on saponified polyvinyl acetate resin. The polyvinyl acetate resin may be one of a homopolymer of vinyl acetate and a copolymer obtained by copolymerizing the vinyl acetate with a monomer capable of being copolymerized with the vinyl acetate. The monomer capable of being copolymerized with the vinyl acetate may be one of unsaturated carboxylic acid, olefin, vinyl ether, and unsaturated sulfonic acid, for example.

The first protective film PRT1 is disposed on the first polarizing film POL1 and protects the first polarizing film POL1 from external scratches.

The anti-glare film AG is disposed on the first protective film PRT1. In an exemplary embodiment, the anti-glare film AG may be directly applied to the first protective film PRT1 and cured, thereby being formed on and attached to the first protective film PRT1. In an alternative exemplary embodiment, the anti-glare film AG may be manufactured separately from the first protective film PRT1 and is disposed on the first protective film PRT1 with adhesives disposed between the anti-glare film AG and the first protective film PRT1, thereby being attached to the first protective film PRT1.

FIG. 6 is a cross-sectional view of an exemplary embodiment of the anti-glare film AG on the first protective film PRT1, according to the invention.

Referring to FIG. 6, in an exemplary embodiment, the anti-glare film AG includes a matrix MX. The matrix MX may include particles PC that provide inner haze therein.

The matrix MX may include or be formed of an organic polymer compound. In one exemplary embodiment, for example, the organic polymer may include one of various monofunctional or multifunctional (meta) acrylate compounds, epoxy compounds, oxetane compounds, etc.

The particles PC disposed in the matrix MX have a predetermined shape. Shape of a top surface of the matrix MX may be on determined based on the disposition and the shape of the particles PC. The particles PC have a refractive index different from the matrix MX. In an exemplary embodiment, the particles PC may have a spherical or elliptical shape, for example, but not being limited thereto. In an alternative exemplary embodiment, the shape of the particles PC may be variously modified.

In an exemplary embodiment, the particles PC may include or be formed of one of an inorganic compound and an organic compound. In such an embodiment, the inorganic compound, for example, may include silicon dioxide, titanium dioxide, aluminum oxide, zirconium oxide, calcium carbonate, magnesium carbonate, talc, clay, calcined kaolin, calcined calcium silicate, hydrated calcium silicate, aluminum silicate, magnesium silicate, calcium phosphate or a combination thereof. In such an embodiment, the organic compound, for example, may include pulverized-classified material of an organic polymer compound such as polytetrafluorethylene, cellulose acetate, polystyrene, polymethylmethacrylate, polypropylmethacrylate, polymethyl acrylate, polyethylene carbonate, acryl styrene resin, silicone resin, polycarbonate resin, benzoguanamine resin, melamine resin, polyolefin powder, polyester resin, polyamide resin, polyimide resin, polyfluoroethylene resin, starch, or a combination thereof.

The particles PC include particles having a grain size smaller than a thickness of the anti-glare film AG. In an exemplary embodiment, an average diameter of the particles PC may be in a range, for example, from about 5 nanometers (nm) to about 0.5 micrometer (μm). The content of the particles PC in the matrix MX may be in a range from about 0.01 weight percent (wt %) to about 1 wt % based on the matrix MX.

The anti-glare film AG includes an uneven portion defining outer haze by scattering light on a top surface thereof. The uneven portion includes a convex portion and/or a concave portion. In an exemplary embodiment, the anti-glare film AG may further include a flat portion on a top surface thereof. A shape of the uneven portion on the surface of the anti-glare film AG or a ratio between areas of the uneven portion and the flat portion is not particularly limited and may be variously set to provide an anti-glare effect. In such an embodiment, a size or shape of the convex portion and/or concave portion may not be uniform and may have irregular size or shape.

In an exemplary embodiment, the uneven portion may be defined based on a shape and distribution of particles PC therein in the top surface of the anti-flare film AG, but not being limited thereto. In an alternative exemplary embodiment, the uneven portion may be provided independently of the shape of the particles PC. In one exemplary embodiment, for example, the top surface of the matrix MX is pressurized using an additional mold formed with an uneven pattern and is transferred with the uneven pattern, thereby providing the uneven portion on the top surface of the matrix MX. Herein, the terms “haze” may be defined as a value indicating a scattering ratio of light penetrating a certain layer or film as percent. The “outer haze” may mean a degree of scattering occurring at an interface between the matrix MX and the air, and the “inner haze” may mean a degree of scattering occurring at an interface between the matrix MX and the particles PC.

Referring to FIGS. 4 and 5, the first compensation film CPN1 compensates a viewing angle with respect to light penetrating the first polarizing plate PLZ1. The first compensation film CPN1 may be elongated at one axis or two axes. In an exemplary embodiment, as shown in FIGS. 4 and 5, the first compensation film CPN1 may be elongated at two axes.

Hereinafter, in the first compensation film CPN1, one surface of the first compensation film CPN1 defines an x-y plane, an upper direction in a width direction defines a z-axis, and refractive indexes of the respective directions are denote by nx, ny and nz. Also, an optical axis of light penetrating the first compensation film CPN1 is defined as a first optical axis RX1, a direction of the first optical axis RX1 defines a z′-axis. The first optical axis RX1 is allowed to face a top of the first compensation film CPN1 and a plane passing the x-axis and perpendicular to the z′-axis is defined as an x-y′ plane. Refractive indexes with respect to a y′-axis and the z′-axis are denoted by ny′ and nz′, respectively.

When the plane perpendicular to the first optical axis RX1 of the first compensation film CPN1 and passing the x-axis defines the x-y′ plane, a first retardation value Rₒ′ of the first compensation film CPN1 is defined as (nₓ−n_{y}′)×d, and a second retardation value Rₜₕ′ of the first compensation film CPN1 is defined as [(nₓ+n_{y}′)/2−n_{z}′]×d, the first retardation value and the second retardation value satisfy the following Formula 1: 0.92≦Rth′/Ro′≦4.75. Herein, ‘d’ denotes a thickness of the first compensation film CPN1 in a direction of the z-axis.

In the first compensation film CPN1, respective refractive indexes nx, ny′, and nz′ with respect to the x-axis, y′-axis, and z′-axis have values different from one another. That is, nx≠ny′≠nz′. In an exemplary embodiment, the respective refractive indexes nx, ny′, and nz′ with respect to the x-axis, y′-axis, and z′-axis may satisfy nx>ny′≧nz′.

The first retardation value is a retardation value with respect to the x-y′ plane, and the second retardation value is a retardation value with respect to the z′-axis of the compensation film. In one exemplary embodiment, for example, while satisfying the Formula 1, the first retardation value may be in a range from about 40 nm to about 100 nm and the second retardation value may be in a range from about 110 nm to about 200 nm. When the first retardation value is less than 40 nm and when the second retardation value is less than 110 nm, the first compensation film CPN1 may not effectively function as a compensation film since not only it is difficult to manufacture such a compensation film but also the retardation values are too small. In such an embodiment, when the first retardation value is greater than 100 nm and when the second retardation value is greater than 200 nm, the first compensation film CPN1 may not have predetermined or desired transmittance and viewing angle since not only it is difficult to match the liquid crystal panel LCP with the first polarizing film POL1 having such retardation values but also the retardation values are too great.

As described above, in the first compensation film CPN1, the first optical axis RX1 is defined not along the z-axis but along the z′-axis due to elongation occurring while being manufactured and the first optical axis RX1 inclines toward the z-axis. An angle (β) between the first optical axis RX1 and the z-axis on a cross section may be in a range from about 10 degrees to about 25 degrees. On the cross section, the first optical axis RX1 inclines with the angle (β) toward a line parallel to the first polarizing axis PX1. That is, the x-y′ plane of the first compensation film CPN1 inclines with the angle (β) toward the line parallel to the first polarizing axis PX1.

The first compensation film CPN1 may include or be formed of thermoplastic resin. In an exemplary embodiment, the thermoplastic resin, for example, includes polysulfone, polymethyl methacrylate, polystyrene, polycarbonate, polyvinyl chloride, norbornene or a combination thereof. The first compensation film CPN1 having a structure described above may be manufactured using a melt-extrusion method. In an exemplary embodiment, the first compensation film CPN1 may be manufactured by allowing thermoplastic resin to be in a state close to a glass transition temperature of the thermoplastic resin, preliminarily elongating the thermoplastic resin by allowing the thermoplastic resin to pass through between rollers with different rotation speeds, and secondarily elongating the thermoplastic resin by allowing the thermoplastic resin to pass through rollers disposed in a different direction from the rollers. The thermoplastic resin shows isotropy in the state close to the glass transition temperature but is formed with anisotropy through the preliminary elongation and is controlled in degree of a gradient of an optical axis thereof through the secondary elongation. The preliminary elongation is performed in a direction for allowing the thermoplastic resin to be substantially parallel to the first polarizing axis PX1 and the secondary elongation is performed in a direction intersecting with the first polarizing axis PX1. Angles of performing the preliminary elongation and the secondary elongation may be determined based on a kind of the thermoplastic resin, the intensity of elongation, and the angle (β) between the first optical axis RX1 and the z-axis of the first compensation film CPN1 to be manufactured on the cross section. In an exemplary embodiment, the preliminary elongation may be performed in a direction of about 45±10 degrees and the secondary elongation may be performed in a direction of about 315±10 degrees.

In an exemplary embodiment, in the liquid crystal panel LCP, the first alignment film ALN1 may be disposed between the first substrate BS1 and the liquid crystals LC and may be rubbed in a direction substantially parallel to the first polarizing axis PX1. In such an embodiment, the first alignment film ALN1 may be rubbed to have a direction in a range of about 45±10 degrees

The second polarizing plate PLZ2 includes a second compensation film CPN2 disposed on the bottom surface of the liquid crystal panel LCP, a second polarizing film POL2 disposed on the second compensation film CPN2, and a second protective film PRT2 disposed on the second polarizing film POL2.

The second polarizing plate PLZ2 is substantially identical to the first polarizing plate PLZ1 except for an anti-glare layer. In such an embodiment, the second polarizing film POL2, the second compensation film CPN2 and the second protective film PRT2 are arranged in substantially the same way as the first polarizing film POL1, the second compensation film CPN1 and the first protective film PRT1, respectively. The same or like elements will be labeled with the same reference characters as used above to describe the first polarizing plate PLZ1 except, and any repetitive detailed description thereof may be omitted or simplified.

The second polarizing film POL2 has a second polarizing axis PX2 intersecting with the first polarizing axis PX1. In an exemplary embodiment, the second polarizing axis PX2 has a direction of about 135±10 degrees.

The second protective film PRT2 is disposed on the second polarizing film POL2 and protects the second polarizing film POL2 from external scratches.

The second compensation film CPN2 compensates a viewing angle with respect to light penetrating the first polarizing plate PLZ1.

In the second compensation film CPN2, one surface of the second compensation film CPN2 defines an x-y plane, a lower direction in a width direction defines a z-axis, and refractive indexes of the respective directions are denoted by nx, ny and nz. Herein, an optical axis of light penetrating the second compensation film CPN2 is referred to as a second optical axis RX2, the second optical axis RX2 defines a z′-axis. The second optical axis RX2 is allowed to face a bottom of the compensation film and a plane passing the x-axis and perpendicular to the z′-axis is designated as an x-y′ plane. Refractive indexes with respect to a y′-axis and the z′-axis are denoted by ny′ and nz′, respectively.

The second compensation film CPN2 has substantially the same configuration of the first compensation film CPN1 except directions of the z-axis and the second optical axis RX2. In an exemplary embodiment, when the plane perpendicular to the second optical axis RX2 and passing the x-axis defines the x-y′ plane, a first retardation value Ro′ of the second compensation film CPN2 is defined as (nₓ−n_{y}′)×d, and a second retardation value Rth′ of the second compensation film CPN2 is defined as [(nₓ+n_{y}′)/2−n_{z}′]×d, the first retardation value and the second retardation value satisfy Formula 1 described above. Herein, ‘d’ indicates a thickness of the second compensation film CPN2 in a direction of the z-axis.

In the second compensation film CPN2, respective refractive indexes nx, ny′ and nz′ with respect to the x-axis, y′-axis and z′-axis have values different from one another. That is, nx ny′ nz′. In an exemplary embodiment, the respective refractive indexes nx, ny′ and nz′ with respect to the x-axis, y′-axis and z′-axis may satisfy the following inequation: nx>ny′≧nz′.

The first retardation value is a retardation value with respect to the x-y′ plane, and the second retardation value is a retardation value with respect to the z′-axis of the compensation film. In an exemplary embodiment, while satisfying the Formula 1, the first retardation value may be in a range from about 40 nm to about 100 nm and the second retardation value may be in a range from about 110 nm to about 200 nm. When the first retardation value is less than 40 nm and when the second retardation value is less than 110 nm, the second compensation film CPN2 may not effectively function as a compensation film since not only it is difficult to manufacture a compensation film having such retardation values but also the retardation values are too small. Also, when the first retardation value is greater than 100 nm and when the second retardation value is more than 200 nm, the second compensation film CPN2 may not effectively provide desired or predetermined transmittance and viewing angle since not only it is difficult to match the liquid crystal panel LCP with the second polarizing film POL2 but also the retardation values are too great.

As described above, in the second compensation film CPN2, the second optical axis RX2 is defined in the z′-axis, which is different from z-axis, due to elongation occurring while being manufactured and the second optical axis RX2 inclines toward the z-axis. An angle (β) between the second optical axis RX2 and the z-axis on a cross section may be in a range from about 10 degrees to about 25 degrees. On the cross section, the second optical axis RX2 inclines with the angle (β) toward a line parallel to the second polarizing axis PX2. That is, the x-y′ plane of the second compensation film CPN2 inclines with the angle (β) toward the line parallel to the second polarizing axis PX2.

The second compensation film CPN2 may be manufactured in the same way as the first compensation film CPN1. In an exemplary embodiment, the second compensation film CPN2 may be manufactured by allowing thermoplastic resin to be in a state close to a glass transition temperature of the thermoplastic resin, preliminarily elongating the thermoplastic resin by allowing the thermoplastic plastic to pass through between rollers with different rotation speeds, and secondarily elongating the thermoplastic resin by allowing the thermoplastic plastic to pass through rollers disposed in a different direction from the rollers. The preliminary elongation is performed in a direction for allowing the thermoplastic resin to be substantially parallel to the second polarizing axis PX2 and the secondary elongation is performed in a direction intersecting with the second polarizing axis PX2. Angles of performing the preliminary elongation and the secondary elongation may vary with a kind of the thermoplastic resin, the intensity of elongation, and the angle (β) between the second optical axis RX2 and the z-axis to be manufactured on the cross section. In an exemplary embodiment, the preliminary elongation may be performed in a direction of about 135±10 degrees and the secondary elongation may be performed in a direction of about 225±10 degrees.

In an exemplary embodiment, in the liquid crystal panel LCP, the second alignment film ALN2 may be disposed between the first substrate BS1 and the liquid crystals LC and may be rubbed in a direction substantially parallel to the second polarizing axis PX2. In an exemplary embodiment, the second alignment film ALN2 may be rubbed to have a direction in a range of about 45±10 degrees

According to an exemplary embodiment, a reddish phenomenon of images in the LCD including is substantially reduced.

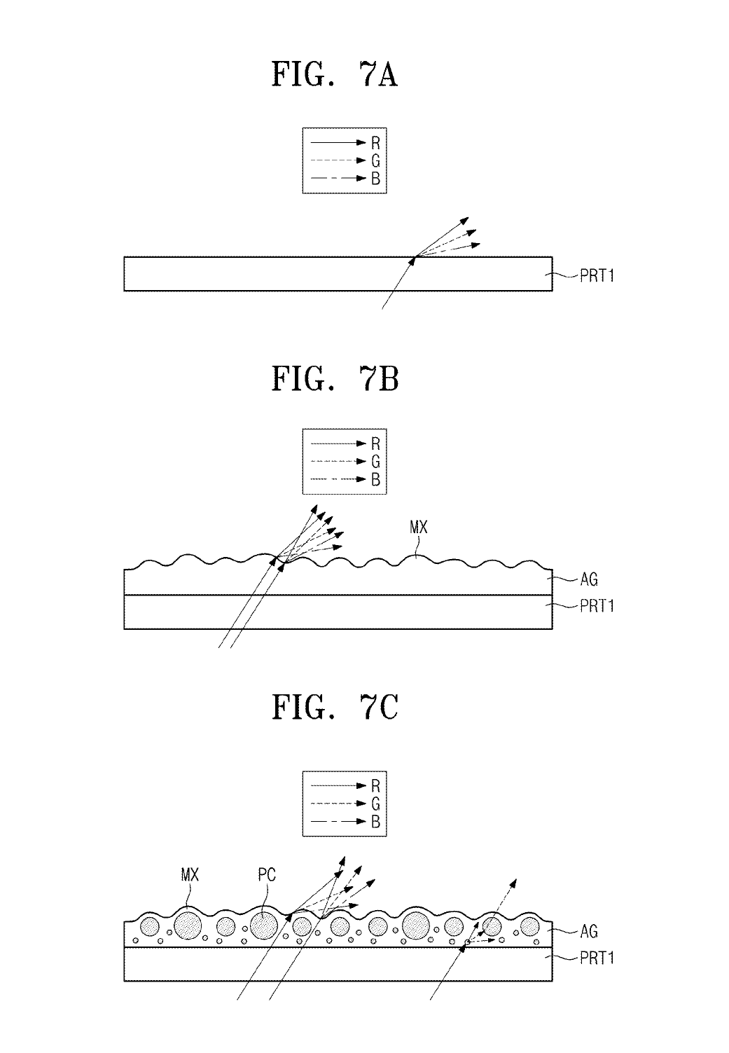

FIGS. 7A to 7C are cross-sectional views illustrating light passing through only the first protective film PRT1 or both the first protective film PRT1 and the anti-glare film AG.

FIG. 7A illustrates the behavior of light passing through the first protective film PRT1. The light passing through first protective film PRT1 is refracted according to Snell's law. According to Snell's law, as a wavelength the light is shorter, a refractive index corresponding thereto increases. Accordingly, a blue light having a short wavelength has a great refractive angle, and a red light having a long wavelength has a relatively shorter refractive angle. Accordingly, in the eye of a user located in front thereof, the red light is relatively better viewed than the blue light, thereby causing the reddening of images.

FIG. 7B is a cross-sectional view illustrating the behavior of light passing through both the first protective film PRT1 and the anti-glare film AG. Particularly, FIG. 7B shows a path of the light scattered by the uneven portion on the surface of the matrix of the anti-glare film AG.

Referring to FIG. 7B, since the uneven portion is provided on the anti-glare film AG, a blue light, a green light and a red light are refracted with mutually different angles for each point on the surface of the uneven portion. According thereto, finally, lights in respective wavelength ranges are mixed with one another, thereby effectively preventing the reddening of images.

FIG. 7C is a cross-sectional view illustrating the behavior of light passing through the first protective film PRT1 and the anti-glare film AG. Particularly, FIG. 7C shows a path of light scattered by the particles PC in the anti-glare film AG, in addition to the uneven portion on the surface of the anti-glare film AG.

Referring to FIG. 7C, in addition to the uneven portion on the surface of the anti-glare film AG, the particles PC in the anti-glare film AG scatter the light. Since the particles PC have a refractive index different from the matrix MX, the light is scattered at an interface between the matrix MX and the particles PC. Since the blue light, green light and red light are scattered with mutually different refractive angles at the interface between the matrix MX and the particles PC, the lights in the respective wavelength ranges are mixed with one another, thereby effectively preventing the reddening of images. When a value of the outer haze caused by the uneven portion increases, the reddening may be effectively prevented but a contrast ratio may be reduced. However, in an exemplary embodiment, where the particles PC is provided in the anti-glare film AG, when a value of the inner haze caused by the particles PC increases, an increase in white turbidity or a decrease in the contrast ratio may not occur such that the reddening may be effectively prevented without deterioration in image quality.

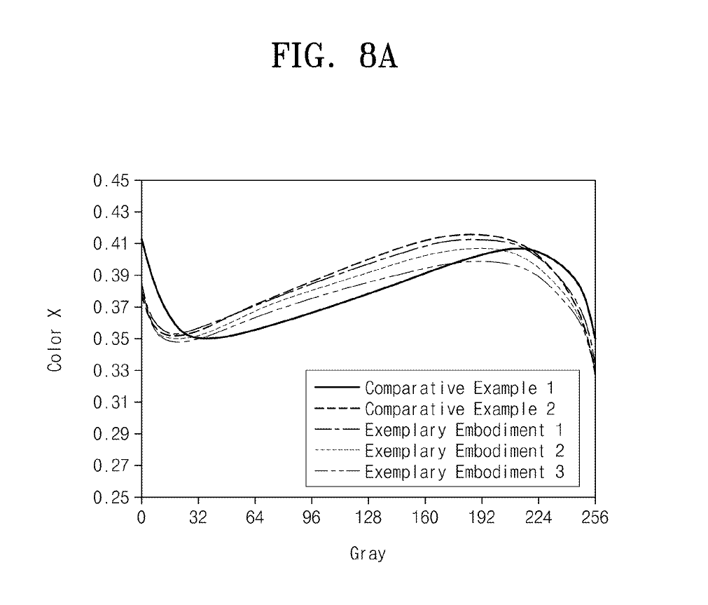

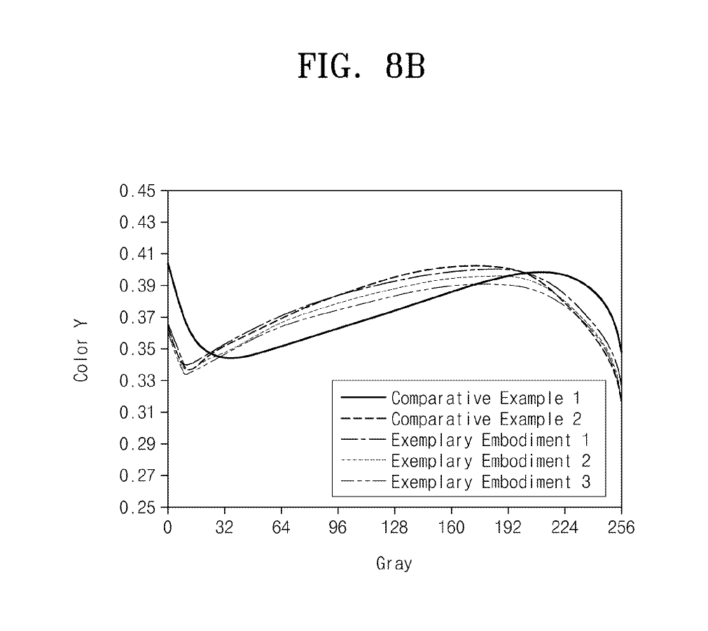

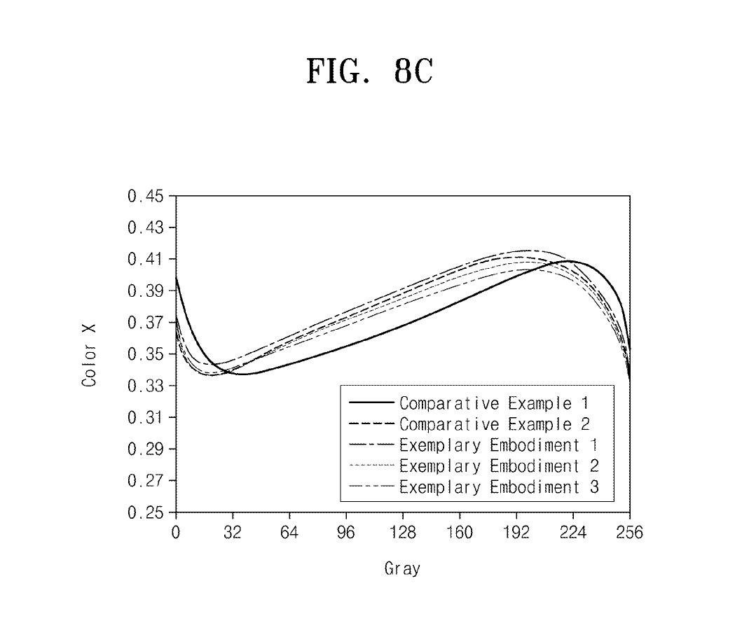

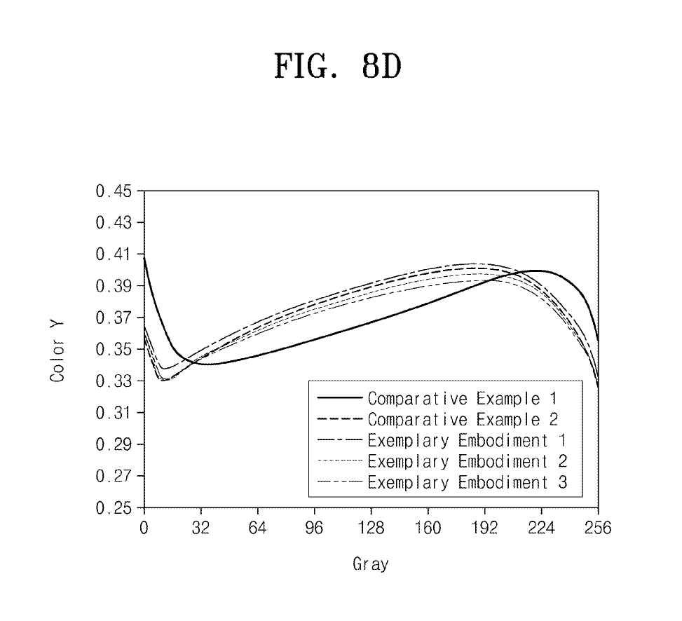

FIGS. 8A to 8D are graphs illustrating variations in values of x and y in color coordinates CIE 1931 versus grayscale level in comparative examples and exemplary embodiments of the invention. In FIGS. 8A to 8D, FIG. 8A illustrates an x-coordinate in a left viewing angle of 60 degrees, FIG. 8B illustrates a y-coordinate in the left viewing angle of 60 degrees, FIG. 8C illustrates an x-coordinate in a right viewing angle of 60 degrees, and FIG. 8D illustrates a y-coordinate in the right viewing angle of 60 degrees. Herein, the grayscale level of zero (0) indicates black, and the grayscale level of 256 indicates white.

A comparative example 1 is an LCD including a typical discotic liquid crystal (“DLC”) compensation film having an outer haze value of 30 and a comparative example 2 is an LCD identical to the exemplary embodiments of the invention only except an anti-glare film. An exemplary embodiment 1 is an exemplary embodiment of the LCD according to the invention, including an anti-glare film having an outer haze value of 30, an exemplary embodiment 2 is exemplary embodiment of the an LCD according to the invention, including an anti-glare film having an outer haze value of 37, and an exemplary embodiment 3 is exemplary embodiment of the an LCD according to the invention, including an anti-glare film having an outer haze value of 25 and an inner haze value of 20. A compensation film of the exemplary embodiments of the LCD according to the invention is set with a first retardation value of about 70 nm, a second retardation value of 170 nm, and an angle (β) between a first optical axis and a z-axis, of about 19 degrees.

Referring to FIGS. 8A to 8D, in the exemplary embodiments 1 to 3 including the anti-glare films, both the x value and y value are generally reduced comparison with the comparative example 2 without the anti-glare film. When the x value and the y value are reduced, the reddening of images decreases.

When comparing the exemplary embodiment 1 with the exemplary embodiment 2, since a reduction in the x value and the y value increases as the haze value of the anti-glare film increases, the effect of preventing the reddening becomes greater as the haze value of the anti-glare film increases.

When comparing the respective exemplary embodiments 1 and 2 with the exemplary embodiment 3, the reduction in the x value and the y value more increases in a case where the inner haze value is added to the outer haze value, than a case where only the outer haze value is present. Accordingly, the effect of preventing the reddening is greater in a case where the inner haze value is added to the outer haze value, than a case where only the outer haze value is present. Particularly, the exemplary embodiment 3 shows a color coordinate value similar to or corresponding to the LCD using a high-priced discotic liquid crystal DLC compensation film.

Tables 1 to 4 illustrate x values and y values in the grayscale level of 224 corresponding to FIGS. 8A to 8D, respectively. The grayscale level of 224, in FIGS. 8A to 8D, corresponds to grayscale level showing the greatest x value and y value. In Tables 1 to 4, the comparative example 2, the exemplary embodiment 1, the exemplary embodiment 2, and the exemplary embodiment 3 show x values and y values when the second retardation value varies from 150, 160, 170, to 180.

TABLE 1

| First retardation | | | | | |
|---|---|---|---|---|---|
| value | | | | | |
| (except | | | | | |
| comparative | Comparative | Comparative | Exemplary | Exemplary | Exemplary |
| example 1) | example 1 | example 2 | embodiment 1 | embodiment 2 | embodiment 3 |
| 150 | 0.4061 | 0.4254 | 0.4243 | 0.4174 | 0.4095 |
| 160 | 0.4061 | 0.4241 | 0.4230 | 0.4161 | 0.4082 |
| 170 | 0.4061 | 0.4143 | 0.4132 | 0.4065 | 0.3988 |
| 180 | 0.4061 | 0.4005 | 0.3994 | 0.3930 | 0.3855 |

TABLE 2

| First retardation | | | | | |
|---|---|---|---|---|---|
| value | | | | | |
| (except | | | | | |
| comparative | Comparative | Comparative | Exemplary | Exemplary | Exemplary |
| example 1) | example 1 | example 2 | embodiment 1 | embodiment 2 | embodiment 3 |
| 150 | 0.3985 | 0.4210 | 0.4216 | 0.4160 | 0.4100 |
| 160 | 0.3985 | 0.4083 | 0.4089 | 0.4034 | 0.3976 |
| 170 | 0.3985 | 0.4014 | 0.4020 | 0.3966 | 0.3909 |
| 180 | 0.3985 | 0.4007 | 0.4013 | 0.3959 | 0.3903 |

TABLE 3

| First retardation | | | | | |
|---|---|---|---|---|---|
| value | | | | | |
| (except | | | | | |
| comparative | Comparative | Comparative | Exemplary | Exemplary | Exemplary |
| example 1) | example 1 | example 2 | embodiment 1 | embodiment 2 | embodiment 3 |
| 150 | 0.4082 | 0.4483 | 0.4515 | 0.4412 | 0.4367 |
| 160 | 0.4082 | 0.4264 | 0.4295 | 0.4197 | 0.4154 |
| 170 | 0.4082 | 0.4116 | 0.4146 | 0.4051 | 0.4010 |
| 180 | 0.4082 | 0.4126 | 0.4156 | 0.4060 | 0.4019 |

TABLE 4

| First retardation | | | | | |
|---|---|---|---|---|---|
| value | | | | | |
| (except | | | | | |
| comparative | Comparative | Comparative | Exemplary | Exemplary | Exemplary |
| example 1) | example 1 | example 2 | embodiment 1 | embodiment 2 | embodiment 3 |
| 150 | 0.3994 | 0.4224 | 0.4245 | 0.4158 | 0.4132 |
| 160 | 0.3994 | 0.4100 | 0.4120 | 0.4046 | 0.4011 |
| 170 | 0.3994 | 0.4019 | 0.4039 | 0.3966 | 0.3932 |
| 180 | 0.3994 | 0.4021 | 0.4041 | 0.3968 | 0.3934 |

As shown in Tables 1 to 4, when compared with the comparative example 2 without the anti-glare film, the exemplary embodiments 1 to 3 including the anti-glare films are all reduced in both the x value and y value. As described above, the reddening of images decreases as the x value and the y value are reduced.

When comparing the exemplary embodiment 1 with the exemplary embodiment 2, since a reduction in the x value and the y value increases as the haze value of the anti-glare film increases, it is shown that the effect of preventing the reddening is great as the haze value of the anti-glare film increases. Comparing the respective exemplary embodiments 1 and 2 with the exemplary embodiment 3, the reduction in the x value and the y value more increases in a case where the inner haze value is added to the outer haze value than a case where only the outer haze value is present. Accordingly, it is shown that the effect of preventing the reddening is great in a case where the inner haze value is added to the outer haze value than a case where only the outer haze value is present. Particularly, the exemplary embodiment 3 shows a color coordinate value similar to or corresponding to the LCD using a high-priced DLC compensation film. In addition, in case of the exemplary embodiment 2, not only the x value and the y value are reduced to prevent the reddening but also more excellent colors are shown in comparison with the comparative example 1.

In exemplary embodiments of the invention, when calculating a haze value of an anti-glare for effectively preventing the reddening considering FIGS. 8A to 8D and Tables 1 to 4, the total haze value including inner and outer haze is about 45 or greater when the second retardation value is from about 145 nm to about 155 nm, the total haze value is about 37 or greater when the second retardation value is from about 155 nm to about 165 nm, a total haze value is about 30 or greater when the second retardation value is from about 165 nm to about 175 nm, and the total haze value is greater than zero (0) when the second retardation value is from about 175 nm to about 185 nm.

Although not described in detail, changes in color coordinate were measured while fixing the second retardation value and/or the angle (β) between the first optical axis and the z-axis and changing the first retardation value. However, there was only a slight effect in color coordinate in comparison with the change in the second retardation value and reddening was maintained intactly.

Table 5 shows a result of estimating contrast ratio CR in a particular viewing angle in the comparative examples and exemplary embodiments.

TABLE 5

| | | | | CR of |
|---|---|---|---|---|
| | CR of top 80 | CR of bottom 80 | CR of left 80 | right 80 |
| | degrees | degrees | degrees | degrees |
| Comparative | 13.4 | 13.9 | 19.5 | 17.0 |
| example 1 | | | | |
| Comparative | 20.4 | 19.1 | 18.3 | 16.0 |
| example 2 | | | | |
| Exemplar | 20.8 | 21.2 | 21.3 | 17.8 |
| embodiment 1 | | | | |
| Exemplary | 24.3 | 21.6 | 24.8 | 20.9 |
| embodiment 2 | | | | |
| Exemplary | 21.0 | 19.5 | 22.2 | 18.4 |
| embodiment 3 | | | | |

Referring to FIG. 5, all the comparative example 1, the exemplary embodiment 1, the exemplary embodiment 2, and the exemplary embodiment 3 show more improved contrast ratios than the comparative example 1. Particularly, the contrast ratios were measured at top, bottom, left, and right viewing angles of about 80 degrees, which indicates that the comparative example 1, the exemplary embodiment 1, the exemplary embodiment 2, and the exemplary embodiment 3 using the compensation films have wide viewing angles. In case of the exemplary embodiments 1 to 3, different from the comparative example 1, although formed with the anti-glare films, there is no great difference in the contrast ratios. Partially, there is shown a greater contrast ratio in case of the exemplary embodiments 1 to 3.

As described above, according to exemplary embodiments of the invention, an LCD include a compensation film that may be manufactured with low cost, and effectively prevents reddening simultaneously with providing images having wide viewing angle properties and an improved contrast ratio.

The above-disclosed subject matter is to be considered illustrative and not restrictive, and the appended claims are intended to cover all such modifications, enhancements, and other embodiments, which fall within the true spirit and scope of the invention. Thus, to the maximum extent allowed by law, the scope of the invention is to be determined by the broadest permissible interpretation of the following claims and their equivalents, and shall not be restricted or limited by the foregoing detailed description.

What is claimed is:

1. A liquid crystal display comprising:
a liquid crystal panel which displays images on a surface thereof;
two polarizing films disposed on opposing surfaces of the liquid crystal panel, respectively;
two compensation films disposed between the liquid crystal panel and the two polarizing films, respectively;
two protective films disposed on outer surfaces of the two polarizing films, respectively; and
an anti-glare layer disposed on one of the two protective films in a direction of displaying the images.

2. The liquid crystal display of claim 1, wherein the anti-glare layer comprises a matrix having an uneven portion on a surface thereof.

3. The liquid crystal display of claim 2, wherein the anti-glare layer further comprises particles disposed in the matrix.

4. The liquid crystal display of claim 3, wherein the matrix and the particles have different refractive indexes from each other.

5. The liquid crystal display of claim 1, wherein
the two polarizing films comprise:
a first polarizing film disposed on one of the opposing surfaces of the liquid crystal panel and having a first polarizing axis; and
a second polarizing film disposed on the other of the opposing surfaces of the liquid crystal panel and having a second polarizing axis, and
the two compensation films comprise:
a first compensation film disposed between the liquid crystal panel and the first polarizing film and having a first optical axis; and
a second compensation film disposed between the liquid crystal panel and the second polarizing film and having a second optical axis.

6. The liquid crystal display of claim 5, wherein
one surface of each of the first and second compensation films defines an x-y plane on the respective compensation film,
the first or second optical axis of each of the first and second compensation films defines a z′-axis on the respective compensation films,
a surface perpendicular to the first or second optical axis and passing an x-axis of the x-y plane on each of the first and second compensation films defines an x-y′ plane on the respective compensation film,
a first retardation value (Ro′) of each of the first and second compensation films is defined as (nx−ny′)×d,
a second retardation value (Rth′) of each of the first and second compensation films is defined as [(nx+ny′)/2−nz′]×d,
the first retardation value and the second retardation value satisfy the following inequation: 0.92≦Rₜₕ′/Rₒ′≦4.75,
wherein
nx denotes a refractive index of the respective compensation film in the x-axis,
ny′ denotes a refractive index of the respective compensation film in the y′-axis,
nz′ denotes a refractive index of the respective compensation film in the z′-axis,
d denotes a thickness of the respective compensation film in a z-axis perpendicular to the x-y plane.

7. The liquid crystal display of claim 6, wherein
the first retardation value of each of the first and second compensation films is a retardation value with respect to the x-y′ plane thereon, and
the second retardation value of each of the first and second compensation films is a retardation value with respect to the z′-axis thereon.

8. The liquid crystal display of claim 7, wherein
a total haze value of the anti-glare layer is about 45 or greater when the second retardation value is in a range from about 145 nanometers to about 155 nanometers,
the total haze value of the anti-glare layer is about 37 or greater when the second retardation value is in a range from about 155 nanometers to about 165 nanometers,
the total haze value of the anti-glare layer is about 30 or greater when the second retardation value is in a range from about 165 nanometers to about 175 nanometers, and
the total haze value of the anti-glare layer is greater than zero (0) when the second retardation value is in a range from about 175 nanometers to about 185 nanometers.

9. The liquid crystal display of claim 7, wherein an angle between the optical axis and the z-axis of each of the first and second compensation films is in a range of from about 10 degrees to about 25 degrees.

10. The liquid crystal display of claim 9, wherein
the x-y′ plane of the first compensation film is titled to a line parallel to the first polarizing axis by the angle between the optical axis and the z-axis of the first compensation film, and
the x-y′ plane of the second compensation film is titled to a line parallel to the second polarizing axis by the angle between the optical axis and the z-axis of the first second compensation film.

11. The liquid crystal display of claim 1, wherein the liquid crystal panel comprises:
a first substrate;
a second substrate opposite to the first substrate; and
liquid crystals disposed between the first substrate and the second substrate, wherein the liquid crystals are twisted nematic liquid crystals.

12. The liquid crystal display of claim 11, wherein dielectric constant anisotropy of the twisted nematic liquid crystals is in a range from about 7 to about 13.

13. The liquid crystal display of claim 12, wherein a retardation value of the twisted nematic liquid crystals is in a range from about 400 nanometers to about 480 nanometers.

14. The liquid crystal display of claim 12, further comprising:
a first alignment film disposed between the first substrate and the liquid crystals and aligned in a direction of a first polarizing axis of a first polarizing film of the two polarizing films; and
a second alignment film disposed between the second substrate and the liquid crystals and aligned in a direction of a second polarizing axis a second polarizing film of the two polarizing films.

15. The liquid crystal display of claim 1, wherein each of the two compensation films comprises thermoplastic resin.

16. The liquid crystal display of claim 15, wherein
one surface of each of two compensation films defines as an x-y plane on the respective compensation film,
an optical axis of each of the two compensation films defines a z′-axis on the respective compensation film,
a surface perpendicular to the optical axis of one of the two compensation films and passing an x-axis of the x-y plane of the one of the two compensation films defines an x-y′ plane on the one of the two compensation films, and
refractive indices each of the two compensation films satisfy the following inequation: nx>ny′≧nz′,
wherein
nx denotes a refractive index of the respective compensation film in the x-axis,
ny′ denotes a refractive index of the respective compensation film in the y′-axis, and
nz′ denotes a refractive index of the respective compensation film in the z′-axis.
